(19) United States
(12) Patent Application Publication
(10) Pub. No.: US 2011/0032246 A1
(43) Pub. Date: Feb. 10, 2011

(54) DISPLAY DEVICE USING MEMS AND DRIVING METHOD THEREOF

(75) Inventors: Sung-Jin HONG, Seoul (KR); Jae-Byung PARK, Seoul (KR); Don-Chan CHO, Seongnam-si (KR); Hyun-Min CHO, Seoul (KR); Yu-Kwan KIM, Incheon (KR); Seul LEE, Seoul (KR)

Correspondence Address: CANTOR COLBURN LLP, 20 Church Street, 22nd Floor, Hartford, CT, 06103, US

(73) Assignee: SAMSUNG ELECTRONICS CO., LTD., Suwon-si (KR)

(21) Appl. No.: 12/652,958

(22) Filed: Jan. 6, 2010

(30) Foreign Application Priority Data
Aug. 7, 2009 (KR) 10-2009-0072981

(51) Int. Cl. G06F 3/038; G02B 26/02

(52) U.S. Cl. 345/214; 359/230

(57) ABSTRACT

A display device using a microelectromechanical system (“MEMS”) element includes; a display panel including the MEMS element having at least three states, the at least three states including an on state, a half-on state, and an off state and a backlight unit which provides light to the display panel.

This application claims priority to Korean Patent Application No. 10-2009-0072981, filed on Aug. 7, 2009, and all the benefits accruing therefrom under 35 U.S.C. §119, the content of which in its entirety ibis herein incorporated by reference.

### BACKGROUND OF THE INVENTION

(a) Field of the Invention

The present invention relates to a display device using a microelectromechanical system (“MEMS”) and a driving method thereof.

(b) Description of the Related Art

Various flat panel displays have been actively researched for use as a next generation display device. A typical flat panel display is a display device that is thin compared with the size of the screen, e.g., the thickness is orders of magnitude smaller than the width and height of the display. In addition, a display device including a miniature modulator using a microelectromechanical system (“MEMS”) within every pixel has recently been the subject of research. The MEMS is formed using a micro-sized processing technique, and an electronic device system produced thereby has a size ranging from only several nanometers to only several millimeters. This display device using the MEMS having high photo-efficiency compares favorably with the typical liquid crystal display (“LCD”).

However, the typical display device using the MEMS has only an on-off characteristic, such as for reflecting or not reflecting, or closing or opening a shutter, e.g., the typical display device using the MEMS system is binary in function, such that in order to display various grayscales the MEMS element uses temporal driving to generate differing grayscale levels, for example a single pixel may be driven to be on and off several times during a short time for representing grays and colors, and accordingly the driving margin is narrow.

### BRIEF SUMMARY OF THE INVENTION

The present invention increases the driving margin of a display device using the microelectromechanical system (“MEMS”), and reduces power consumption of a display using the associated MEMS.

In one exemplary embodiment, a display device using a MEMS element includes a display panel including the MEMS element having at least three states, the at least three states including an on state, a half-on state, and an off state, and a backlight unit which provides light to the display panel.

In one exemplary embodiment, the MEMS element may include an aperture plate including an opening, a shutter capable of covering at least a portion of the opening, and at least one control electrode which controls a position of the shutter.

In one exemplary embodiment, the shutter may cover only a portion of the opening when the MEMS element is in the half-on state.

In one exemplary embodiment, the shutter may have a restoring force which returns the shutter to a reference position in which the shutter covers only a portion of the opening when the MEMS element is in the half-on state.

In one exemplary embodiment, the shutter may substantially completely open the opening when the MEMS element is in the on state.

In one exemplary embodiment, the shutter may substantially completely cover the opening when the MEMS element is in the off state.

In one exemplary embodiment, the at least one control electrode may include a first control electrode which controls the shutter to cover the opening, and a second control electrode which controls the shutter to open the opening.

In one exemplary embodiment, the first control electrode, the second control electrode, and the shutter may be applied with a first voltage when the MEMS element is in the half-on state.

In one exemplary embodiment, the first voltage may be a common voltage Vcom.

In one exemplary embodiment, when the MEMS element is in the on state, the first control electrode and the shutter may be commonly applied with a first voltage, and the second control electrode may be applied with a second voltage that is different from the first voltage.

In one exemplary embodiment, when the MEMS element is in the off state, the second control electrode and the shutter may be applied with a first voltage, and the first control electrode may be applied with a second voltage that is different from the first voltage.

In one exemplary embodiment, the display device may further include a lower substrate and an upper substrate disposed facing the first substrate, wherein the MEMS element is disposed between the lower substrate and the upper substrate, wherein the shutter may move substantially parallel to at least one of a surface of the lower substrate and the upper substrate, and wherein the first control electrode and the second control electrode are disposed substantially opposite each other with the shutter disposed therebetween.

In one exemplary embodiment, the display device may further include a lower substrate and an upper substrate disposed facing the lower substrate, wherein the MEMS element is disposed between the lower substrate and the upper substrate, wherein the first control electrode may be disposed such that a longest dimension thereof is substantially parallel to a surface of the lower substrate, and the second control electrode may be disposed such that a longest dimension thereof is substantially vertical to the surface of the lower substrate, and wherein the shutter may swing between the first control electrode and the second control electrode.

In one exemplary embodiment, the backlight unit may alternately display different primary colors sequentially in time.

An exemplary embodiment of a driving method of a display device using a MEMS element having a display panel and a backlight unit which provides light to the display panel, wherein the display panel includes a pixel and the pixel includes at least three states, the lat least three states comprising an on state, a half-on state, and an off state according to an exemplary embodiment of the present invention includes; receiving an image signal represented in an n numerical system, wherein n is greater than or equal to 3, applying a data signal corresponding to a digit value of each digit of the image signal to the pixel wherein the digit value is between 0 and n−1, and operating for the MEMS element to have a state among the at least three states corresponding to the digit value of each digit.

In one exemplary embodiment, the driving method may further include; emitting light from the backlight to display an image, wherein a duration time of the light emission may be proportional to a digit value of each digit of the image signal.

In one exemplary embodiment, the image signal may be separately provided per primary color, and the image signal respectively corresponding to primary colors may be sequentially displayed.

In one exemplary embodiment, the pixel may include a plurality of subpixels respectively displaying a plurality of primary colors.

In one exemplary embodiment, the MEMS element may include an aperture plate having an opening, a shutter capable of covering at least a portion of the opening, and a control electrode controlling a position of the shutter.

In one exemplary embodiment, the control electrode may be applied with a data voltage, and the data voltage includes a first voltage and a second voltage that is different from the first voltage.

According to the present invention, the MEMS structure has three states, and a driving method thereof may improve the driving margin of the display device and simultaneously the power consumption may be reduced.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1, FIG. 2, FIG. 3, and FIG. 4 are cross-sectional views showing three states of an exemplary embodiment of a microelectromechanical system (“MEMS”) element in a display device using a MEMS according to the present invention;

FIG. 5, FIG. 6, FIG. 7, and FIG. 8 are cross-sectional views showing three states of another exemplary embodiment of an MEMS element in a display device using a MEMS according to the present invention;

FIG. 9 is a block diagram of an exemplary embodiment of a display device using a MEMS according to the present invention;

FIG. 10 is a view showing an exemplary embodiment of a method for representing a color and a gray during one frame of an exemplary embodiment of a display device using an exemplary embodiment of an MEMS according to the present invention;

FIG. 11 is a block diagram of another exemplary embodiment of a display device using an exemplary embodiment of an MEMS according to the present invention; and

FIG. 12 is a view showing another exemplary embodiment of a method for representing a color and a gray during one frame of an exemplary embodiment of a display device using an exemplary embodiment of an MEMS according to the present invention.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be described in detail with reference to the accompanying drawings.

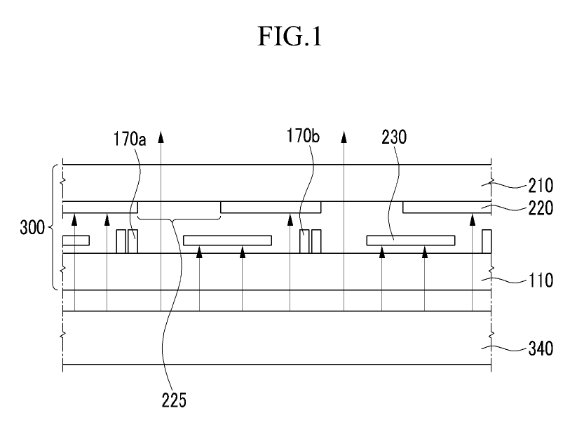

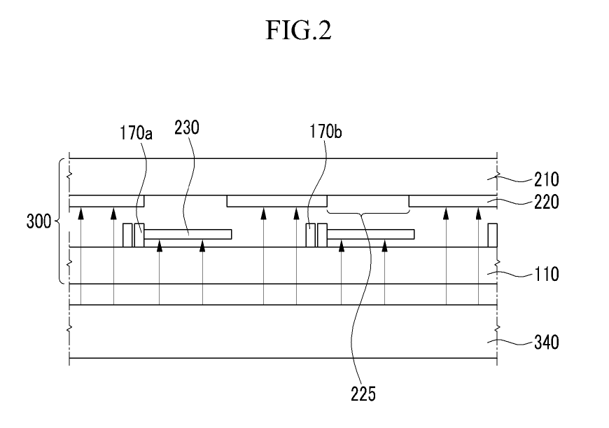

Firstly, an exemplary embodiment of a display device using a microelectromechanical system (“MEMS”) according to the present invention will be described with reference to FIG. 1, FIG. 2, FIG. 3, and FIG. 4.

FIG. 1, FIG. 2, FIG. 3, and FIG. 4 are cross-sectional views showing three states of an exemplary embodiment of a MEMS element in a display device using a MEMS according to the present invention.

An exemplary embodiment of a display device using the MEMS according to the present invention includes a display panel 300 including a lower substrate 110 and an upper substrate 210 facing to each other and a MEMS element interposed between two substrates 110 and 210, and a backlight unit 340 providing light to the display panel 300.

Exemplary embodiments of the lower substrate 110 and the upper substrate 210 may be made a transparent insulating material, exemplary embodiments of which include transparent glass, plastic or other materials with similar characteristics.

In the present exemplary embodiment, the MEMS element includes an aperture plate 220, a shutter 230, a first control electrode 170a, and a second control electrode 170b.

Exemplary embodiments of the aperture plate 220 may be made of a material through which light is not transmitted on the upper substrate 210. The aperture plate 220 also includes a plurality of openings 225 transmitting the light therethrough. The openings 225 are arranged at predetermined intervals across the display panel 300.

In one exemplary embodiment, the first control electrode 170a and the second control electrode 170b may be formed on the lower substrate 110. One first control electrode 170a and one second control electrode 170b are formed in a pair and are arranged at a predetermined interval from one another, and in one exemplary embodiment the predetermined interval may be substantially the same as the distance between same side boundaries of adjacent openings 225. Also, the first control electrode 170a and the second control electrode 170b are disposed outside of the boundary of the opening 225 of the aperture plate 220, and in the illustrated exemplary embodiment, the first control electrode 170a is directly disposed outside of the boundary of the opening 225 and the second control electrode 170b is disposed beside the first control electrode 170a. The first control electrode 170a and the second control electrode 170b are applied with a common voltage Vcom or a predetermined voltage.

The shutter 230 has a shape and an area corresponding to the opening 225 of the aperture plate 220 such that the shutter 230 may completely cover the opening 225. Exemplary embodiments of the shutter 230 may be made of a material through which light is not transmitted. The shutter 230 is disposed between the first control electrode 170a and the second control electrode 170b, and has a restoring force which, in the absence of an applied electric field, moves the shutter to a reference position which covers only a portion of the opening 225. The shutter 230 may be moved in right and left directions parallel to the substrates 110 and 210 with respect to the reference position, and when the shutter 230 is positioned at the reference position, only a portion of the opening 225 of the aperture plate 220 may be covered. In one exemplary embodiment, the reference position corresponds to a position wherein half of the opening 225 is covered by the shutter 230. Here, the first control electrode 170a is positioned at the side near the shutter 230 with respect to the opening 225, and the second control electrode 170b is positioned at the other side; however, alternative exemplary embodiments include alternative configurations.

In one exemplary embodiment, the shutter 230 may be connected to a supporting unit (not shown) supporting the shutter 230 to float over the lower substrate 110 and to move the shutter 230 in the right and left directions with respect to the reference position. The supporting unit may have a shape such as a plate spring or a curved spring so that the supporting unit may have elastic force so that the shutter 230 may be restored to the reference position after the shutter 230 is moved in the right and/or left directions.

Exemplary embodiments include configurations wherein the shutters 230 may be separated from each other, and two or more shutters 230 may be connected to each other. In one exemplary embodiment, the shutter 230 may be applied with the common voltage Vcom.

The backlight unit 340 provides light toward the display panel 300, and white light may be provided or light of more than two primary colors may be alternatively provided. An example of the primary colors may be three primary colors such as red, green, and blue.

One opening 225, one shutter 230 corresponding thereto, and a pair of a first control electrode 170a and a second control electrode 170b disposed on respective sides of the shutter 230 form one MEMS element. Exemplary embodiments include configurations wherein one pixel of the display panel 300 may include one MEMS element or a plurality of MEMS elements.

Next, the operation of the MEMS element will be described with reference to FIGS. 1-4.

Firstly, referring to FIG. 1, the shutter 230, the first control electrode 170a, and the second control electrode 170b are applied with the same voltage such as the common voltage Vcom. Thus, a voltage difference between the shutter 230 and the first control electrode 170a, and between the shutter 230 and the second control electrode 170b, does not exist, e.g., the difference is 0, such that the shutter 230 does not move but is maintained at the reference position, thereby a rightmost portion of the opening 225 is covered as seen from a cross-sectional view. Accordingly, light from the backlight unit 340 passing through the opening 225 that is not covered by the shutter 230 is passed to the outside and may be recognized from the outside. This state of MEMS element is referred to as a half-on/half-off state. Here, the shutter 230 may cover about half of the corresponding opening 225, but the reference position may be determined to be appropriate for the characteristics of the display device.

Next, referring to FIG. 2, the shutter 230 and the second control electrode 170b are applied with the common voltage Vcom, and the first control electrode 170a is applied with a different voltage from the common voltage Vcom. The voltage applied to the first control electrode 170a may have a negative or a positive polarity with respect to the common voltage Vcom. Thus, an attraction force is generated between the shutter 230 and the first control electrode 170a by the difference between the voltage of the shutter 230 and the voltage of the first control electrode 170a such that the shutter 230 moves toward the first control electrode 170a. Accordingly, the shutter 230 completely covers the corresponding opening 225 such that light from the backlight unit 340 is completely blocked by the shutter 230. This state is referred to as an off state. Although the second electrode 170b is described as having the same voltage as the shutter 230, alternative exemplary embodiments include configurations wherein the voltage of the second electrode 170b may also be changed, as long as the voltage difference between the shutter 230 and the first electrode 170a is of a greater magnitude than the voltage difference between the shutter 230 and the second electrode 170b. If the first control electrode 170a is applied with the common voltage Vcom, the shutter 230 is again returned to the reference position.

Next, referred to FIG. 3, the shutter 230 and the first control electrode 170a are applied with the common voltage Vcom, and the second control electrode 170b is applied with the different voltage from the common voltage Vcom. The voltage applied to the second control electrode 170b may have the positive or the negative polarity with respect to the common voltage Vcom. Thus, the attraction force is generated between the shutter 230 and the second control electrode 170b by the difference between the voltage of the shutter 230 and the voltage of the second control electrode 170b such that the shutter 230 moves toward the second control electrode 170b. Accordingly, the shutter 230 completely opens the corresponding opening 225 such that light from the backlight unit 340 may emit toward outside through the completely opened opening 225. This state is referred to as an on state. Although the first electrode 170a is described as having the same voltage as the shutter 230, alternative exemplary embodiments include configurations wherein the voltage of the first electrode 170a may also be changed, as long as the voltage difference between the shutter 230 and the second electrode 170b is of a greater magnitude than the voltage difference between the shutter 230 and the first electrode 170a. If the second control electrode 170b is applied with the common voltage Vcom, the shutter 230 is returned to the reference position.

As described above, the exemplary embodiment of a MEMS element of the exemplary embodiment of a display device according to the present invention has three states, e.g., the on state in which the opening 225 is completely opened maximizing the transmittance of light, the half-on state in which only a portion of the opening 225 is opened, and the off state in which the opening 225 is completely closed such that light may not be transmitted therethrough. Accordingly, the pixel of the display panel 300 including this MEMS element may represent three grays (also referred to as degrees of gradation) through one operation. That is, if the gray of the on state is defined to be “2”, the gray of the half-on state is “1”, and the gray of the off state is “0”.

Referring to FIG. 4, in the exemplary embodiment in which the shutter 230 covers half of the opening 225 at the reference position, when the MEMS element is changed to the on state or the off state, the shutter 230 moves by half (d/2) of the width (d) of the opening 225. Accordingly, the distance that the shutter 230 must moves between adjacent grays may be reduced by half and the power consumption of the display device may be reduced compared with the MEMS element having only two states of the on state and the off state. Differently from FIG. 4, when the shutter 230 covers a portion of the opening 225 other than half with respect to the reference position, the distance the shutter 230 must moves is also reduced compared with the MEMS element having only the two states of the on state and the off state such that power consumption may be reduced.

Though the present exemplary embodiment of a MEMS element has three states, alternative exemplary embodiments of the MEMS element may have four states or more through methods of controlling the voltage of the first control electrode 170a and the second control electrode 170b, or by controlling the supporting unit of the shutter 230.

Also, differently from the present exemplary embodiment, the shutter 230 may be controlled through a single control electrode or at least three control electrodes, and in such an exemplary embodiment the voltages of the control electrode and the shutter may be appropriately controlled.

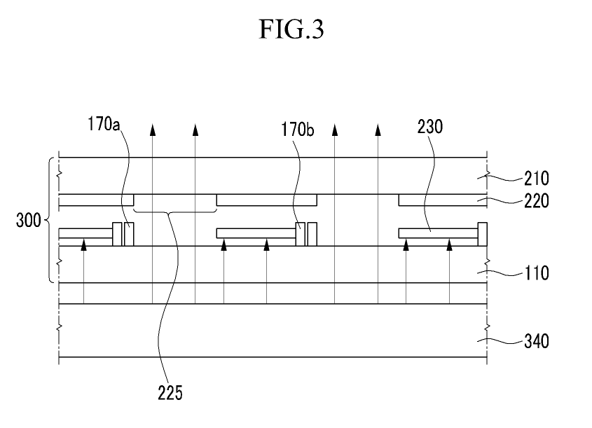

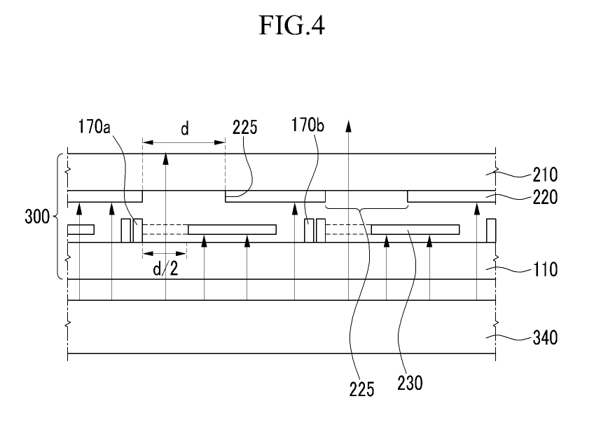

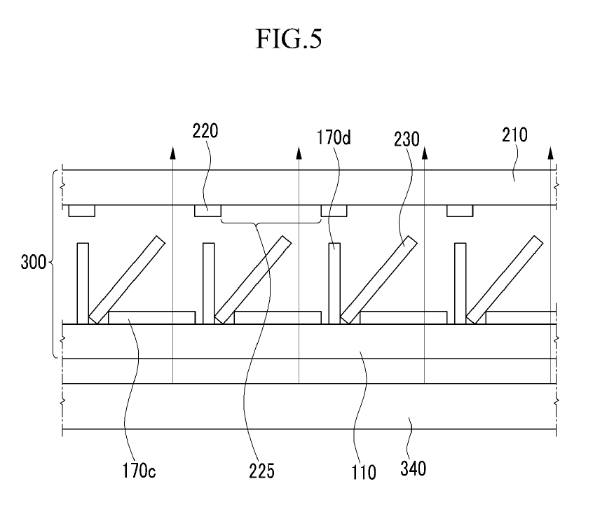

Next, another exemplary embodiment of a display device including another exemplary embodiment of a MEMS element according to the present invention will be described with reference to FIG. 5, FIG. 6, FIG. 7, and FIG. 8. The same constituent elements as in the previous exemplary embodiment are indicated by the same reference numerals, and duplicative description is omitted.

FIG. 5, FIG. 6, FIG. 7, and FIG. 8 are cross-sectional views showing three states of another exemplary embodiment of a MEMS element in a display device using a MEMS according to the present invention.

An exemplary embodiment of a display device using the MEMS according to the present invention includes a display panel 300 including a lower substrate 110 and an upper substrate 210 facing each other and a MEMS element interposed between two substrates 110 and 210, and a backlight unit 340 providing light to the display panel 300.

Similar to the previous exemplary embodiment, the lower substrate 110 and the upper substrate 210 may be made a transparent insulating material, exemplary embodiments of which include transparent glass, plastic or other materials having similar characteristics.

The MEMS element includes an aperture plate 220, a shutter 230, a first control electrode 170c, and a second control electrode 170d.

The aperture plate 220 is made of a material through which light is not transmitted and is disposed on the upper substrate 210, and has a plurality of openings 225 transmitting the light therethrough. The openings 225 are arranged at predetermined intervals across the display 300.

In the present exemplary embodiment, the first control electrode 170c and the second control electrode 170d may be formed on the lower substrate 110. The long edge (also referred to as an expansion direction) of the first control electrode 170c may be formed to be substantially parallel to the surface of the lower substrate 110 on the lower substrate 110, and the first control electrodes 170c are arranged to oppose respective openings 225. The long edge (also referred to as an expansion direction) of the second control electrode 170d may be perpendicular to the surface of the lower substrate 110 on the lower substrate 110, and is substantially arranged with the same pitch as the opening 225. That is, the first control electrode 170c and the second control electrode 170d are approximately perpendicular to one another and are alternately arranged throughout the display 300. The first control electrode 170c faces the opening 225 of the aperture plate 220, and the second control electrode 170d faces the aperture plate 220 corresponding to regions thereof where the openings 225 are not located. In one exemplary embodiment, the first control electrode 170c and the second control electrode 170d may be made of a transparent conductive material. In one exemplary embodiment, the first control electrode 170c and the second control electrode 170d are applied with a common voltage Vcom or a predetermined voltage.

The shutter 230 has a shape and area covering the opening 225 of the aperture plate 220, and may be made of a material through which light is not transmitted. The shutter 230 is disposed between the first control electrode 170c and the second control electrode 170d. The shutter 230 has a restoring force applied to it in a direction toward a reference position, which forms a predetermined angle that is not 0 degrees with respect to either the first control electrode 170c and the second control electrode 170d. As used herein, the measurement of the described angles is from the point where the second control electrode 170d meets the lower substrate 110. When the shutter 230 is positioned at the reference position, a portion of the opening 225 of the aperture plate 220 may be covered. In one exemplary embodiment, when the shutter 230 is positioned at the reference position, half of the opening 225 of the aperture plate 220 is covered. The shutter 230 may swing between the first control electrode 170c or the second control electrode 170d with respect to the reference position and the origin. That is, the shutter 230 may swing like a hinge attached to the lower substrate 110, and the degree that the opening 225 is covered may be changed by the movement of the shutter 230 about the hinge.

Exemplary embodiments include configurations wherein the shutter 230 may be connected to a supporting unit (not shown) to allow the shutter 230 to swing therefrom, and the supporting unit may have elastic force to return the shutter 230 to the reference position when the shutter 230 is deviated from the reference position and is moved toward the first control electrode 170c or the second control electrode 170d. In one exemplary embodiment, the shutter 230 may be applied with the common voltage Vcom.

The backlight unit 340 provides light toward the display panel 300, and white light may be provided or light more than two of primary colors may be alternatively provided by the backlight 340.

In the present exemplary embodiment, one opening 225, one shutter 230 corresponding thereto, and a pair of a first control electrode 170c and a second control electrode 170d determining the swing angle of the shutter 230 form one MEMS element. Exemplary embodiments include configurations wherein one pixel of the display panel 300 may include one MEMS element or a plurality of MEMS elements.

Next, the operation of the MEMS element will be described in more detail with respect to FIGS. 5-8.

Firstly, referring to FIG. 5, the shutter 230, the first control electrode 170a, and the second control electrode 170b are applied with the same voltage, for example the common voltage Vcom. Thus, a voltage difference between the shutter 230 and the first control electrode 170a, and between the shutter 230 and the second control electrode 170b does not exist, e.g., the voltage difference is 0. In such a configuration the shutter 230 does not move in any direction but is maintained at the reference position such that a leftmost portion of the opening 225 is covered as seen from a cross-sectional view, e.g., FIG. 5. Accordingly, the light from the backlight 340 that passes through the opening 225 that is not covered by the shutter 230 is passed outside and may be recognized from the outside. Therefore, the MEMS element has the half-on/half-off state described in detail above. In one exemplary embodiment the shutter 230 may cover about half of the corresponding opening 225, but the reference position may be determined to be appropriate for the characteristics of the display device.

Next, referring to FIG. 6, the shutter 230 and the second control electrode 170d are applied with the common voltage Vcom, and the first control electrode 170c is applied with a different voltage from the common voltage Vcom. The voltage applied to the first control electrode 170a may have a negative or positive polarity with respect to the common voltage Vcom. Thus, an attraction force is generated between the shutter 230 and the first control electrode 170c due to the difference between the voltage of the shutter 230 and the voltage of the first control electrode 170c such that the shutter 230 moves toward the first control electrode 170c. Accordingly, the shutter 230 overlaps the first control electrode 170c substantially parallel to the first control electrode 170c and completely covers the corresponding opening 225 such that light from the backlight unit 340 is completely blocked thereby. Accordingly, the MEMS element is in an off state. Although the second electrode 170d is described as having the same voltage as the shutter 230, alternative exemplary embodiments include configurations wherein the voltage of the second electrode 170d may also be changed, as long as the voltage difference between the shutter 230 and the first electrode 170a is of a greater magnitude than the voltage difference between the shutter 230 and the second electrode 170d. If the first control electrode 170c is applied with the common voltage Vcom, the shutter 230 is returned to the reference position.

Next, referring to FIG. 7, the shutter 230 and the first control electrode 170c are applied with the common voltage Vcom, and the second control electrode 170d is applied with a different voltage from the common voltage Vcom. The voltage applied to the second control electrode 170d may have positive or the negative polarity with respect to the common voltage Vcom. Thus, an attraction force is generated between the shutter 230 and the second control electrode 170d due to the difference between the voltage of the shutter 230 and the voltage of the second control electrode 170d such that the shutter 230 moves toward the second control electrode 170d. Accordingly, the shutter 230 overlaps the second electrode 170d nearly parallel to the second electrode 170d and opens the corresponding opening 225 such that light from the backlight unit 340 may be emitted outside through the opened opening 225. The shutter 230 may be substantially parallel to the second electrode 170d when the opening 225 is substantially opened. Therefore the MEMS element is in an on state. Although the second electrode 170d is described as having the same voltage as the shutter 230, alternative exemplary embodiments include configurations wherein the voltage of the first electrode 170c may also be changed, as long as the voltage difference between the shutter 230 and the second electrode 170d is of a greater magnitude than the voltage difference between the shutter 230 and the first electrode 170c. If the second control electrode 170d is applied with the common voltage Vcom, the shutter 230 is returned to the reference position.

As described above, the MEMS element of the display device according to an exemplary embodiment of the present invention has three states, of the on state in which the opening 225 is completely opened to maximize the transmittance of the light, the half-on state in which a only a portion of the opening 225 is opened, and the off state in which the opening 225 is completely closed such that light may not be transmitted. Accordingly, the pixel of the display panel 300 including this MEMS element may represent three grays through one operation. That is, if the gray of the on state may be defined to be “2”, the gray of the half-on state is “1”, and the gray of the off state is “0”.

On the other hand, referring to FIG. 8, when the shutter 230 is changed from the reference position to the on state or the off state, the angle that the shutter 230 must moves is less than 90 degrees, e.g., it is less than the full range through which the shutter 230 may move. Accordingly, the angle and the distance that the shutter 230 must move going from one state to the next adjacent state may be reduced such that the power consumption of the display device may be reduced compared with the MEMS element having only the on state and the off state.

Though the MEMS element of the present exemplary embodiment has three states, the MEMS element may have four or more states through methods of controlling the voltage of the first control electrode 170c and the second control electrode 170d, or by controlling the supporting unit of the shutter 230.

Also, differently from the present exemplary embodiment, alternative exemplary embodiments include configurations wherein the shutter may be controlled through one control electrode or at least three control electrodes, and the voltages of the control electrode and in such an alternative exemplary embodiment the shutter may be appropriately controlled.

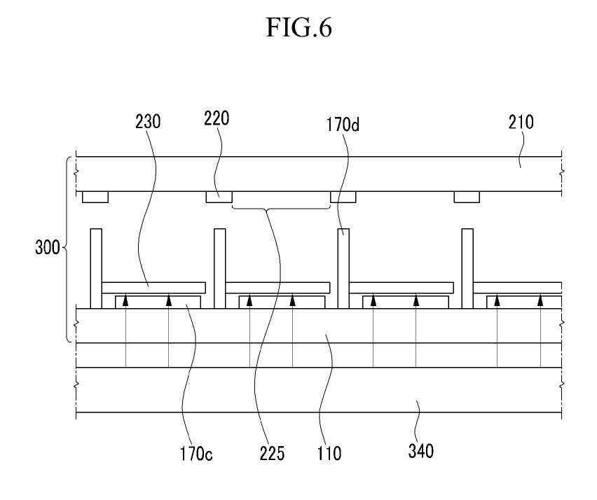

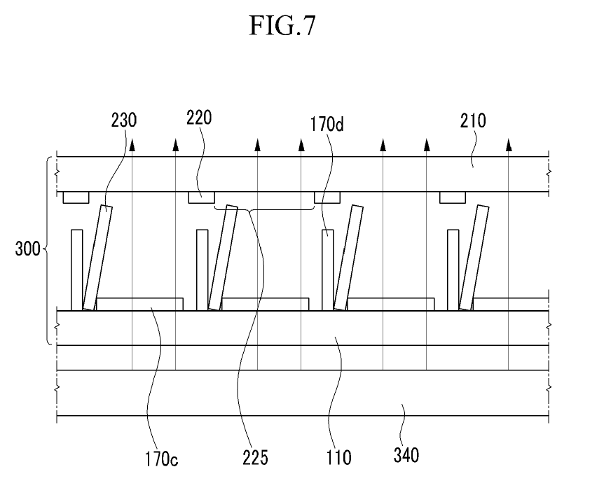

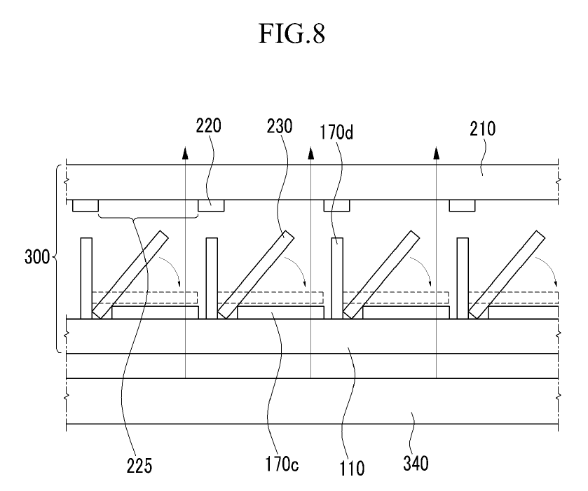

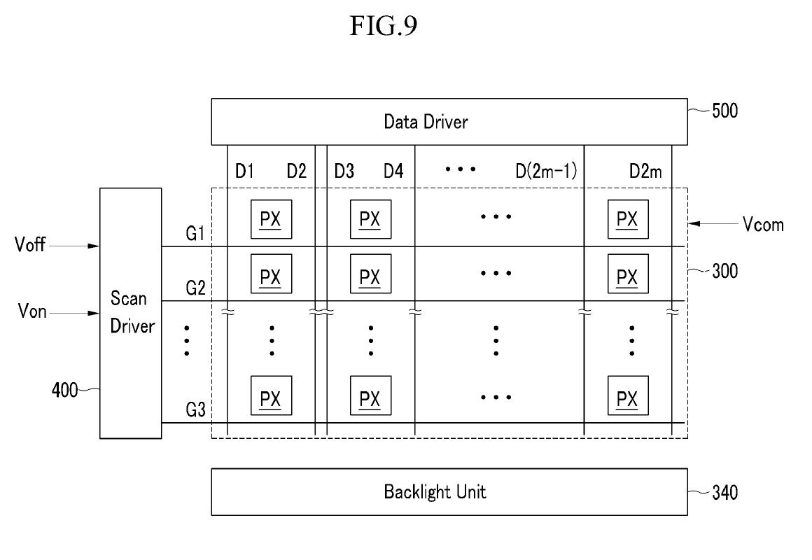

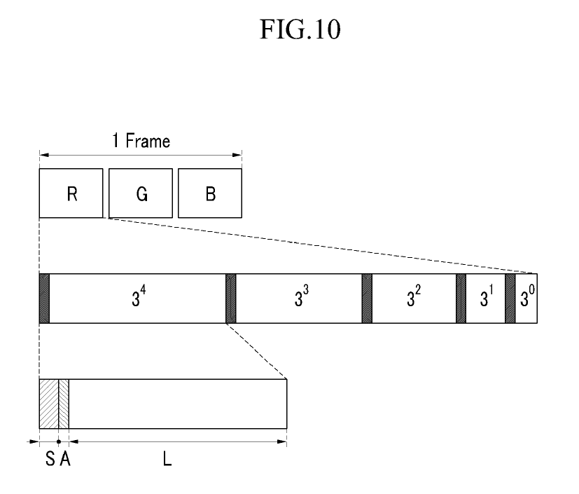

Next, an exemplary embodiment of a display operation of the display device using the MEMS according to the present invention will be described with reference to FIG. 9 and FIG. 10.

FIG. 9 is a block diagram of an exemplary embodiment of a display device using a MEMS according to the present invention, and FIG. 10 is a view showing an exemplary embodiment of a method for representing a color and a gray during one frame of a display device using a MEMS according to the present invention.

Referring to FIG. 9, an exemplary embodiment of a display device using the MEMS according to the present invention includes a display panel 300, a scan driver 400, a data driver 500, and a backlight unit 340.

The display panel 300 includes a plurality of signal lines G1-Gn and D1-D2m, and a plurality of pixels PX connected thereto and arranged substantially in a matrix-shape.

The signal lines include the plurality of scanning lines G1-Gn for transmitting scanning signals, and the plurality of pairs of data lines D1-D2m for transmitting data signals. The gate lines G1-Gn extend substantially in a row direction, and the data lines D1-D2m extend substantially in a column direction. The data lines D1-D2m are disposed in pairs per pixel PX such that each pixel PX is connected with at least two data lines, and the pairs of data lines may be disposed on both sides of one pixel PX. Here, the data voltages include the common voltage Vcom, and a negative or positive predetermined voltage.

Each pixel PX may include a switching element unit (not shown), exemplary embodiments of which include a thin film transistors (“TFT”), and a MEMS element connected to the scanning lines G1-Gn and the data lines D1-D2m. The MEMS element may have the above-described structure and the states that are shown in FIG. 1 to FIG. 4, or FIG. 5 to FIG. 8.

The switching element unit may include a pair of switching elements respectively connected to a pair of data lines D1-D2m disposed on both sides of each pixel PX. A pair of switching elements included in one pixel PX are respectively connected to the first control electrodes 170a or 170c and the second control electrodes 170b or 170d of the MEMS element shown in FIG. 1 to FIG. 4 or FIG. 5 to FIG. 8, thereby transmitting the voltages applied to the data lines D1-D2m to the first and second control electrodes 170a-d.

For color display, each pixel PX alternately displays one of three primary colors (temporal division) as time passes, and a desired color is recognized by a temporal sum of the primary colors. For example, in one exemplary embodiment the primary colors are three primary colors of red, green, and blue.

The scan driver 400 is connected to the scanning lines G1-Gn of the display panel 300 to apply a scanning signal consisting of a combination of a gate-on voltage Von for turning on the switching element and a gate-off voltage Voff for turning off the switching element to the scanning lines G1-Gn.

The data driver 500 is connected to the data lines D1-D2m of the display panel 300 to apply the data voltage to the data lines D1-D2m. The data voltage is changed according to three states of the MEMS element included with the pixel PX, and may be the common voltage Vcom or the different predetermined voltage.

Next, the operation of the display device using the MEMS and the driving method thereof will be described in detail.

In the present exemplary embodiment, an exemplary embodiment in which an image signal representing a gray is formed in a ternary numerical system of five digits (each digit may represent 0, 1, 2) will be described as an example. In such an exemplary embodiment, the image signal has 243 (=3⁵) grays, and 0, 1, and 2 representing each digit may be sequentially recognized as the off state, the half-on state, and the on state of the MEMS element.

Referring to FIG. 10, a full color image of one frame may be realized by alternately displaying primary colors such as three primary colors of red (R), green (G), and blue (B) through one pixel PX over a sequential period of time. The display period of each of the primary colors R, G, and B forms one subframe. In the present exemplary embodiment, red (R), green (G), and blue (B) are sequentially displayed, however the sequence thereof may be changed, and different primary colors may be substituted for those listed here or the order of the display of the primary colors may vary from that described.

In the present exemplary embodiment, the driving operations of the MEMS element are executed 5 times with respect to one pixel PX during one subframe. Each driving operation corresponds to each digit of the image signal in the ternary numerical system of five digits.

Each driving operation includes a scanning period S in which the gate-on voltage Von is sequentially applied to all scanning lines G1-Gn to apply the data voltage to each pixel PX, a MEMS actuation period A in which the MEMS element operates, and a light emitting period L for emitting light from the backlight unit 340 to display images for all pixels PX.

In the scanning period S, the scan driver 400 applies the gate-on voltage Von to the scanning lines G1-Gn according to the control signals such that the switching elements (not shown) connected to the scanning lines G1-Gn are turned on.

Also, the data driver 500 applies the common voltage Vcom or a predetermined voltage other than the common voltage Vcom to the corresponding data lines D1-D2m according to a value of each digit of the image signal for each pixel PX, that is, the state the MEMS element should have. When the most significant digit of the image signal is, for example, 0, the data line D1-D2m connected to the first control electrode 170a through the switching element is applied with the predetermined voltage that is different from the common voltage Vcom, and the data line D1-D2m connected to the second control electrode 170b through the switching element is applied with the common voltage Vcom. When the value of the most significant digit is 1, the first control electrode 170a and the second control electrode 170b are both applied with the common voltage Vcom, and when the value of the most significant digit is 2, the voltages applied are opposite to the case in which the value of the most significant digit is 1.

Thus, the data voltage of the data line D1-D2m is applied to the corresponding pixel PX through the turned-on switching element.

Next, in the MEMS actuation period A, the shutter 230 of the MEMS element of each pixel PX is operated according to the data voltage applied to the data line D1-D2m.

Next, in the light emitting period L, the backlight unit 340 is operated such that the display panel 300 displays an image.

In the present exemplary embodiment, the scanning period S, the MEMS actuation period A, and the light emitting period L are divided, but the periods S, A, and L may be simultaneously operated. That is, the data voltage may be applied to the pixel PX, and simultaneously the MEMS element may be operated and the backlight unit 340 may emit light.

On the other hand, the five light emitting periods L in one subframe may have a different light emitting time according to the position of the digit of the ternary numerical system. That is, if it is assumed that the luminance is proportional to time that the MEMS element is in the on state, the ratio of duration time of the light emitting periods L from the most significant digit to the least significant digit may be the same as the ratio of the digit value of each digit as represented by Equations 1.

3⁴:3³:3²:3¹:3⁰=81:27:9:3:1 <Equation 1>

As described above, the duration time of the light emitting period L are made to be different according to the value of digits of the image signal of the ternary numerical system, and thereby various grays of one subframe may be displayed.

For example, in one exemplary embodiment when the gray of the image signal for red R is 59 during one frame of one pixel PX, this is represented as “02012₃” in the ternary numerical system, in other words, the numeral 59 may be represented as 02012 in base 3, or trinary. The MEMS element of the pixel PX is driven five times during the subframe of red R, and sequentially has the off state 0, the on state 2, the off state 0, the half-on state 1, and the on state 2. Also, the five light emitting periods L have the ratio of duration time of 81:27:9:3:1, and the luminance that is recognized by a user viewing the display is also proportional to this ratio. Accordingly, the temporal sum during one subframe is recognized as the desired red luminance. The cases of the green G and the blue B are the same.

As described above, a gray represented by the ternary numerical system may be realized using a MEMS element having the on state, the half-on state, and the off state, and accordingly the driving operation number may be reduced while displaying a similar number of grays to the case of using a MEMS element including only the on state and the off state. That is, the conventional MEMS element requires eight driving operations per subframe to represent 256 grays per one subframe, but according to an exemplary embodiment of the present invention, only five driving operations are required per subframe to represent 243 grays such that the driving margin may be increased, e.g., the length of each individual driving operation may be increased without increasing the length of the subframe as a whole.

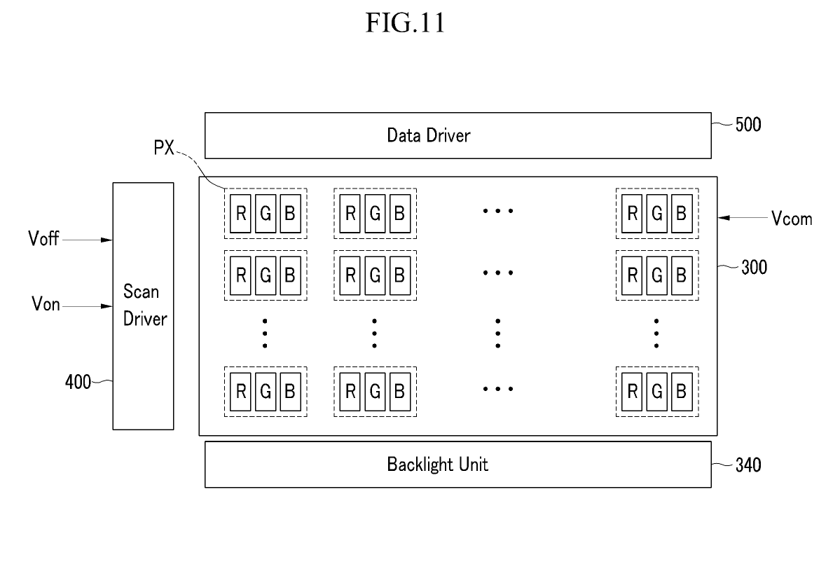

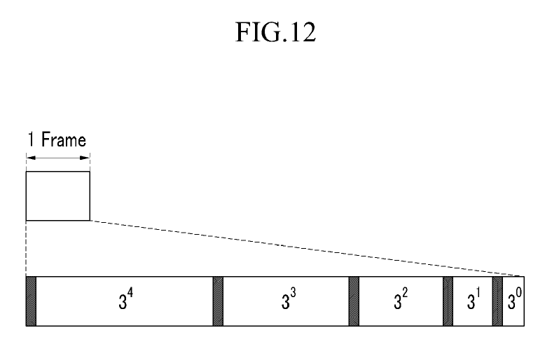

Next, another exemplary embodiment of the operation and the driving method of the display device using the MEMS according to the present invention will be described with reference to FIG. 11 and FIG. 12. The same constituent elements as in the previous exemplary embodiment are indicated by the same reference numerals, and duplicative description is omitted.

FIG. 11 is a block diagram of a display device using another exemplary embodiment of a MEMS according to the present invention, and FIG. 12 is a view showing a method for representing a color and a gray during one frame of a display device using the present exemplary embodiment of a MEMS according to the present invention.

Referring to FIG. 11, an exemplary embodiment of a display device using the MEMS according to the present invention also includes a display panel 300, a scan driver 400, a data driver 500, and a backlight unit 340.

In the present exemplary embodiment, one pixel PX includes three subpixels, different from the previous exemplary embodiment of FIG. 9 and FIG. 10. That is, each subpixel may uniquely display one of three primary colors (spatial division). Exemplary embodiments of the primary colors may include three primary colors of red (R), green (G), and blue (B). Each subpixel may have a color filter displaying one of the three primary colors provided at each region.

Although not shown, the subpixels representing the primary colors of R, G, and B may be connected to a scanning line (not shown) and a pair of data lines (not shown) through the switching element.

Referring to the operation of the display device according to the present exemplary embodiment, which is different from the previous exemplary embodiment, the MEMS element is operated five times during one frame with reference to one pixel PX. The temporal combination of the luminance corresponding to each digit of the image signal in each subpixel and the spatial combination of the primary colors R, G, and B of three subpixels forming one pixel PX may display an image of a desired color and desired luminance during one frame in each subpixel.

In the above-described exemplary embodiment, the gray of the image signal is represented as five digits in the ternary, i.e., base three, numerical system, but it may be realized by various number of digits according to the desired number of grays, e.g., a base four, base five, base six, etc., number system may be used to produce a larger number of possible grays.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device using a microelectromechanical system element, the display device comprising:
a display panel comprising:
the microelectromechanical system element having at least three states, the at least three states including an on state, a half-on state, and an off state; and
a backlight unit which provides light to the display panel.

2. The display device of claim 1, wherein the microelectromechanical system element comprises:
an aperture plate including an opening;
a shutter capable of covering at least a portion of the opening; and
at least one control electrode which controls a position of the shutter.

3. The display device of claim 2, wherein the shutter covers only a portion of the opening when the microelectromechanical system element is in the half-on state.

4. The display device of claim 3, wherein the shutter has a restoring force which returns the shutter to a reference position in which the shutter covers only a portion of the opening when the microelectromechanical system element is in the half-on state.

5. The display device of claim 2, wherein the shutter substantially completely opens the opening when the microelectromechanical system element is in the on state.

6. The display device of claim 2, wherein the shutter substantially completely covers the opening when the microelectromechanical system element is in the off state.

7. The display device of claim 2, wherein the at least one control electrode comprises:
a first control electrode which controls the shutter to cover the opening; and
a second control electrode which controls the shutter to open the opening.

8. The display device of claim 7, wherein the first control electrode, the second control electrode, and the shutter are applied with a first voltage when the microelectromechanical system element is in the half-on state.

9. The display device of claim 8, wherein the first voltage is a common voltage.

10. The display device of claim 7, wherein when the microelectromechanical system element is in the on state, the first control electrode and the shutter are commonly applied with a first voltage, and the second control electrode is applied with a second voltage that is different from the first voltage.

11. The display device of claim 7, wherein when the microelectromechanical system element is in the off state, the second control electrode and the shutter are applied with a first voltage, and the first control electrode is applied with a second voltage that is different from the first voltage.

12. The display device of claim 7, further comprising:
a lower substrate; and
an upper substrate disposed facing the lower substrate,
wherein the microelectromechanical system element is disposed between the lower substrate and the upper substrate,
wherein the shutter moves substantially parallel to at least one of a surface of the lower substrate and a surface of the upper substrate, and
wherein the first control electrode and the second control electrode are disposed substantially opposite each other with the shutter disposed therebetween.

13. The display device of claim 7, further comprising
a lower substrate; and
an upper substrate disposed facing the lower substrate,
wherein the microelectromechanical system element is disposed between the lower substrate and the upper substrate,
wherein the first control electrode is disposed such that a longest dimension thereof is substantially parallel to a surface of the lower substrate, and the second control electrode is disposed such that a longest dimension thereof is substantially vertical to the surface of the lower substrate, and
wherein the shutter swings between the first control electrode and the second control electrode.

14. The display device of claim 1, wherein the backlight unit alternately displays different primary colors sequentially in time.

15. A driving method of a display device using a microelectromechanical system element having a display panel and a backlight unit which provides light to the display panel, wherein the display panel includes a pixel, and the pixel includes at least three states, the at least three states comprising an on state, a half-on state, and an off state, the method comprising:
receiving an image signal represented in an n numerical system, wherein n is greater than or equal to 3;
applying a data signal corresponding to a digit value of each digit of the image signal to the pixel wherein the digit value is between 0 and n−1; and
operating the microelectromechanical system element to have a state among the at least three states corresponding to the digit value of each digit.

16. The driving method of claim 15, further comprising:
emitting light from the backlight unit to display an image, wherein a duration time of the light emission is proportional to the digit value of each digit of the image signal.

17. The driving method of claim 15, wherein the image signal is separately provided per primary colors, and the image signal respectively corresponding to the primary colors is alternately sequentially displayed.

18. The driving method of claim 17, wherein the pixel includes a plurality of subpixels respectively displaying a plurality of primary colors.

19. The driving method of claim 15, wherein the MEMS element comprises:
an aperture plate having an opening;
a shutter capable of covering at least a portion of the opening and
a control electrode which controls a position of the shutter.

20. The driving method of claim 19, wherein the control electrode is applied with a data voltage, and the data voltage includes a first voltage and a second voltage that is different from the first voltage.
